(19) United States
(12) Patent Application Publication
(10) Pub. No.: US 2020/0226461 A1
(43) Pub. Date: Jul. 16, 2020

(54) ASYNCHRONOUS EARLY STOPPING IN HYPERPARAMETER METAOPTIMIZATION FOR A NEURAL NETWORK

(71) Applicant: NVIDIA CORPORATION, Santa Clara, CA (US)

(72) Inventors: Greg HEINRICH, Nice (FR); Iuri FROSIO, San Jose, CA (US)

(21) Appl. No.: 16/248,670

(22) Filed: Jan. 15, 2019

(51) Int. Cl. G06N 3/08; G06N 3/04

(52) U.S. Cl. CPC G06N 3/08; G06N 3/0454

(57) ABSTRACT

One embodiment of a method includes adjusting a plurality of hyperparameters corresponding to a plurality of neural networks trained asynchronously relative to each other using a plurality of computer systems. The method further includes asynchronously measuring one or more performance metrics associated with the plurality of neural networks being trained. The method further includes ceasing the adjusting of the plurality of hyperparameters corresponding to one or more of the plurality of neural networks if the one or more performance metrics associated with the one or more of the plurality of neural networks are below a threshold.

### BACKGROUND

Machine learning models are created based on hyperparameters that affect the training and/or structures of the machine learning models. For example, hyperparameters associated with an artificial neural network (ANN) may include the number of layers in the ANN, a learning rate or step size associated with training of the ANN, a loss function used to update weights associated with neurons in the ANN, and/or the number of training samples inputted into the ANN. As a result, selection of optimal hyperparameters for a machine learning model may result in increased performance of the machine learning model.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and selection engine of FIG. 1, according to various embodiments.

FIG. 3 is a conceptual illustration of a hyperparameter metaoptimization technique performed by the training engine and selection engine of FIG. 1, according to various embodiments.

FIG. 4 is a flow diagram of method steps for performing hyperparameter metaoptimization, according to various embodiments.

FIG. 5 is a block diagram illustrating a computer system configured to implement one or more aspects of various embodiments.

FIG. 6 is a block diagram of a parallel processing unit (PPU) included in the parallel processing subsystem of FIG. 5, according to various embodiments.

FIG. 7 is a block diagram of a general processing cluster (GPC) included in the parallel processing unit (PPU) of FIG. 6, according to various embodiments.

FIG. 8 is a block diagram of an exemplary system on a chip (SoC) integrated circuit, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

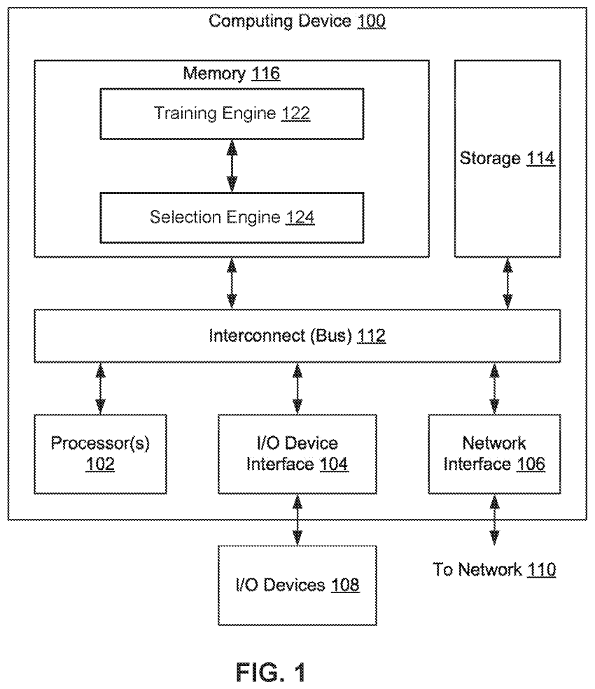

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and selection engine 124 that reside in a memory 116. It is noted that the computing device described herein is illustrative and that any other technically feasible configurations fall within the scope of the present disclosure.

In one embodiment, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and selection engine 124 may be stored in storage 114 and loaded into memory 116 when executed.

In one embodiment, memory 116 includes a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including training engine 122 and selection engine 124.

In one or more embodiments, training engine 122 and selection engine 124 include functionality to perform hyperparameter metaoptimization in an asynchronous distributed manner. In these embodiments, hyperparameter metaoptimization includes identifying a set of hyperparameters that produces a machine learning model with a best or highest performance metric. As discussed in further detail below, such hyperparameter optimization may be performed using multiple processing nodes and training phases in a way that improves parallel utilization of resources and balances between breadth and depth during searching of the hyperparameter space.

### Asynchronous Early Stopping for Hyperparameter Metaoptimization

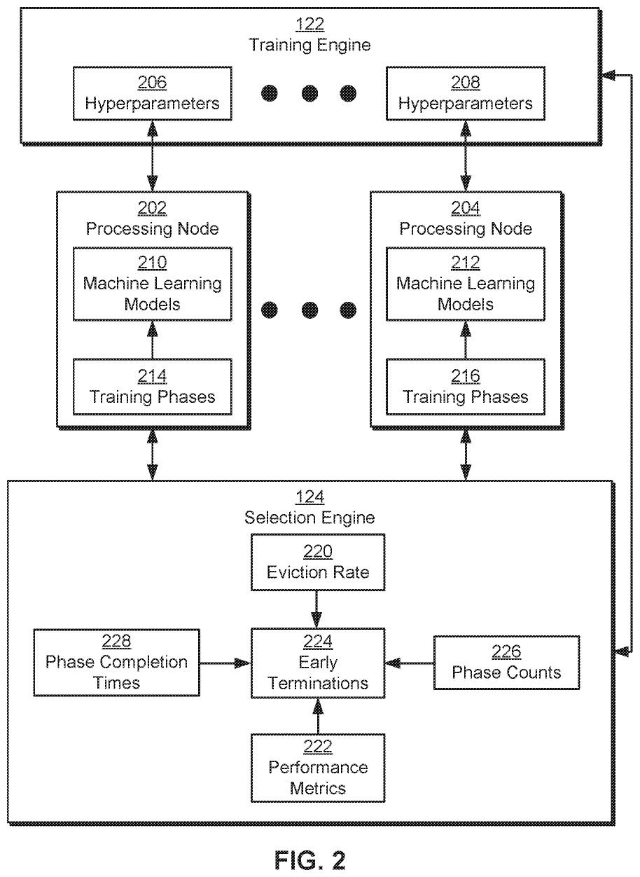

FIG. 2 is a more detailed illustration of training engine 122 and selection engine 124 of FIG. 1, according to various embodiments. In the embodiment shown, training engine 122 trains a number of machine learning models 210-212 on multiple processing nodes 202-204.

In one embodiment, processing nodes 202-204 include computational resources that can be configured to train machine learning models 210-212. For example, individual processing nodes 202-204 may include one or more processors, processor cores, CPUs, GPUs, ASICs, FPGAs, AI accelerators, computer systems, virtual machines, servers, data centers, cloud computing systems, and/or other units or aggregations of units for performing computation or processing.

In one embodiment, processing nodes 202-204 are homogeneous or heterogeneous with respect to one another. In these embodiments, homogeneous processing nodes 202-204 have the same amount of computational or processing resources, while heterogeneous processing nodes 202-204 have different amounts of computational or processing resources. Thus, homogeneous processing nodes 202-204 may perform the same task in the same amount of time, while heterogeneous processing nodes 202-204 may perform the same task in different amounts of time.

In one embodiment, training engine 122 and/or processing nodes 202-204 include functionality to train one or more types of machine learning models 210-212. For example, machine learning models 210-212 produced by training engine 122 may include recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), and/or other types of artificial neural networks or components of artificial neural networks. In another example, machine learning models 210-212 produced by training engine 122 may include functionality to perform clustering, principal component analysis (PCA), latent semantic analysis (LSA), Word2vec, and/or another unsupervised learning technique. In a third example, machine learning models 210-212 produced by training engine 122 may include regression models, support vector machines, decision trees, random forests, gradient boosted trees, naïve Bayes classifiers, Bayesian networks, hierarchical models, and/or ensemble models.

In one embodiment, training engine 122 configures processing nodes 202-204 to create and/or train machine learning models 210-212 using corresponding sets of hyperparameters 206-208. In these embodiments, hyperparameters 206-208 define “higher-level” properties of machine learning models 210-212 instead of internal parameters of machine learning models 210-212 that are updated during training of machine learning models 210-212 and subsequently used to generate predictions, inferences, scores, and/or other output of machine learning models 210-212. For example, hyperparameters 206-208 may include a learning rate (e.g., a step size in gradient descent), a convergence parameter that controls the rate of convergence in a machine learning model, a model topology (e.g., the number of layers in a neural network or deep learning model), a number of training samples in training data for a machine learning model, a parameter-optimization technique (e.g., a formula and/or gradient descent technique used to update parameters of a machine learning model), a data-augmentation parameter that applies transformations to features inputted into machine learning models 210-212 (e.g., scaling, translating, rotating, shearing, shifting, and/or otherwise transforming an image), and/or a model type (e.g., neural network, clustering technique, regression model, support vector machine, tree-based model, ensemble model, etc.). Because hyperparameters 206-208 affect both the complexity of machine learning models 210-212 and the rate at which training of machine learning models 210-212 is performed, computational costs associated with training machine learning models 210-212 may vary.

In one embodiment, training engine 122 searches the hyperparameter space associated with machine learning models 210-212 by using a different set of hyperparameters 206-208 to train each machine learning model. For example, training engine 122 and/or another component may select a different set of hyperparameters 206-208 for each of a certain number of machine learning models 210-212. The component may additionally vary hyperparameters 206-208 across machine learning models 210-212 based on a grid search, random search, and/or other hyperparameter tuning technique. Thus, the component may explore one set of hyperparameters 206-208 with each machine learning model.

In one embodiment, each processing node sequentially trains one or more machine learning models (e.g., machine learning models 210-212) over one or more training phases 214. In one embodiment, each training phase includes a predefined allocation of resources used in training of a machine learning model. For example, a training phase may be defined as a certain amount of time, processor resources, training iterations, and/or other user-defined representation of work.

In one embodiment, training engine 122 and/or processing nodes 202-204 complete training of a machine learning model after the machine learning model has been trained over a certain number of training phases 214. For example, one or more processing nodes may train a machine learning model over up to four training phases; at the end of four training phases, training of the machine learning model is complete.

In one embodiment, processing nodes 202-204 execute asynchronously in parallel to train the machine learning models 210-212 using the corresponding hyperparameters 206-208. As a result, processing nodes 210-212 may execute different training phases 214-216 at a given point in time. After a processing node has finished or stopped training a given machine learning model, the processing node may begin training a new machine learning model using a different set of hyperparameters without waiting for or synchronizing with other processing nodes 210-212.

In one embodiment, selection engine 124 performs asynchronous early stopping during metaoptimization of hyperparameters 206-208. In one embodiment, asynchronous early stopping involves selecting a subset of machine learning models 210-212 undergoing training by training engine 122 for early terminations 224 before training engine 122 completes all training phases associated with the subset. In these embodiments, early terminations 224 are performed based on an eviction rate 220 associated with hyperparameter metaoptimization, performance metrics 222 collected from machine learning models 210-212 at the end of training phases 214-216, phase counts 226 of training phases 214-216 used to train machine learning models 210-212, and phase completion times 228 of training phases 214-216.

In one embodiment, eviction rate 220 represents an expected proportion of machine learning models 210-212 to be targeted for early terminations 224 after each training phase. For example, eviction rate 220 may be specified as a value from 0 to 1 and/or a percentage. In one embodiment, selection engine 124 may use eviction rate 220 as a target proportion of machine learning models 210-212 selected for early terminations 224, with the actual proportion of machine learning models 210-212 selected for early terminations 224 varying due to randomness in the system.

In one embodiment, performance metrics 222 include measurements of performance for machine learning models 210-212. For example, each processing node may generate values of precision, recall, accuracy, receiver operating characteristic (ROC) area under the curve (AUC), observed/expected (O/E) ratio, and/or other performance metrics 222 from a machine learning model at the end of each training phase executed by the processing node to train the machine learning model.

In one embodiment, phase counts 226 include the number of training phases 214-216 completed by processing nodes 202-204 for each machine learning model. For example, phase counts 226 may be reported by processing nodes 202-204 as non-negative integer “phase numbers” that are associated with identifiers for the corresponding machine learning models 210-212.

In one embodiment, phase completion times 228 include the times at which training phases 214-216 are completed for individual machine learning models 210-212. For example, each phase completion time includes a timestamp representing the end of a training phase for a machine learning model. A processing node used to train the machine learning model may output the timestamp with the phase number of the training phase and/or an identifier for the machine learning model once the machine learning model completes the training phase.

In one embodiment, when processing nodes 202-204 include heterogeneous processing resources, processing nodes 202-204 adjust phase completion times 228 to reflect the amount of computational resources used to train the corresponding machine learning models 210-212. For example, a processing node with twice the “baseline” amount of computational resources may adjust the amount of time required to execute a training phase for a machine learning model on the processing node to be double the elapsed amount of time. As a result, the phase completion time of the training phase for the machine learning model may be shifted later by the amount of time required to execute the training phase for the machine learning model.

In one or more embodiments, selection engine 124 initially operates in a “data collection mode” (DCM) at the beginning of each training phase, in which performance metrics 222 are collected from machine learning models 210-212 and/or processing nodes 202-204 and no early terminations 224 are performed. After sufficient performance metrics 222 have been collected within each training phase, selection engine 124 switches to a “selection mode” (SM) in the same training phase, in which a subset of machine learning models 210-212 undergoing training on processing nodes 202-204 are selected for early terminations 224 based on eviction rate 220, performance metrics 222, phase counts 226, and phase completion times 228.

In one embodiment, the operation of selection engine 124 may be illustrated using the following example formula:

E[Wₚ]=W₀(1−r)^{p} (1)

In the above formula, E represents an expected value, Wₚ represents the number of machine learning models 210-212 that reach training phase p, W₀ represents the initial (or total) number of machine learning models 210-212, and r represents eviction rate 220.

In one embodiment, the number of workers Wₚ^{DCM} needed to complete phase p before selection engine 124 switches from DCM to SM in a given training phase may be represented by the following example formula:

Wₚ^{DCM}=W₀(1−\sqrt{r})(1−r)^{p} (2)

After selection engine 124 switches to SM in training phase p, machine learning models 210-212 that report performance metrics 222 in the lower √r quantile are selected for early terminations 224.

In one embodiment selection engine 124 may allow the first W₀(1−\sqrt{r})(1−r)^{p} machine learning models 210-212 that complete a given training phase to continue training in subsequent training phases 214-216, independently of performance metrics 222 for those machine learning models. Conversely, selection engine 124 may require remaining machine learning models 210-212 to have performance metrics 222 that are higher than the quantile threshold if they arrive later than the first W₀(1−\sqrt{r})(1−r)^{p} machine learning models 210-212 in training phase p. In these embodiments, selection engine 124 may use the above equations to achieve the desired eviction rate 220. In one embodiment, selection engine 124 may use other equations and/or techniques to select proportions of machine learning models 210-212 for early terminations 224 in a way that achieves eviction rate 220.

In these embodiments, selection engine 124 balances between breadth and depth in hyperparameter metaoptimization by leveraging unpredictability of scheduling, run time, and performance metrics 222 related to training machine learning models 210-212. For example, selection engine 124 may allow machine learning models 210-212 that finish their training phases 214-216 early or quickly (in DCM) or with high performance metrics 222 (in SM) to continue executing and increase the depth of their search while discouraging subsequent training of other machine learning models 210-212 that complete their training phases 214-216 more slowly or at later points in time.

In one or more embodiments, selection engine 124 communicates one or more machine learning models 210-212 that are selected for early terminations 224 to training engine 122, and training engine 122 ceases to train the machine learning models. In these embodiments, training engine 122 initiates training of new machine learning models on one or more processing nodes 202-204 previously used to train the terminated machine learning models, which allows available computational resources on processing nodes 202-204 to be fully utilized. The hyperparameter metaoptimization process performed by training engine 122 and selection engine 124 may be complete after all machine learning models 210-212 have completed all training phases or have been terminated early before completing all training phases.

In one embodiment, training engine 122, selection engine 124, and/or another component modifies hyperparameters 206-208 associated with one or more machine learning models 210-212 to increase and/or improve exploration of the hyperparameter space. For example, hyperparameters 206-208 of one or more machine learning models 210-212 with lower performance metrics 222 may be changed after a given training phase to be closer to hyperparameters 206-208 of one or more machine learning models 210-212 with higher performance metrics 222 to allow for exploration of the hyperparameter space around the higher-performing machine learning models 210-212. In another example, hyperparameters 206-208 of machine learning models 210-212 with similar performance metrics 222 may be moved away from one another after a given training phase to increase the breadth of exploration of the hyperparameter space. In a third example, one or more hyperparameters 206-208 from a machine learning model that has completed one or more training phases with high performance metrics 222 may be used as a basis for setting hyperparameters 206-208 of machine learning models 210-212 that have yet to start training to explore promising areas of the hyperparameter space and/or to promote a larger exploration of the hyperparameter space.

In one embodiment, training engine 122, selection engine 124, and/or another component schedules the training of machine learning models 210-212 on processing nodes 202-204 based on “a priori” information related to the corresponding sets of hyperparameters 206-208. For example, the component may use knowledge of the computational costs associated with different sets of hyperparameters 206-208 to schedule the training of a machine learning model that is expected to take longer to train before the training of a machine learning model that is expected to take less time to train to allow the machine learning models to complete a training phase at around the same time.

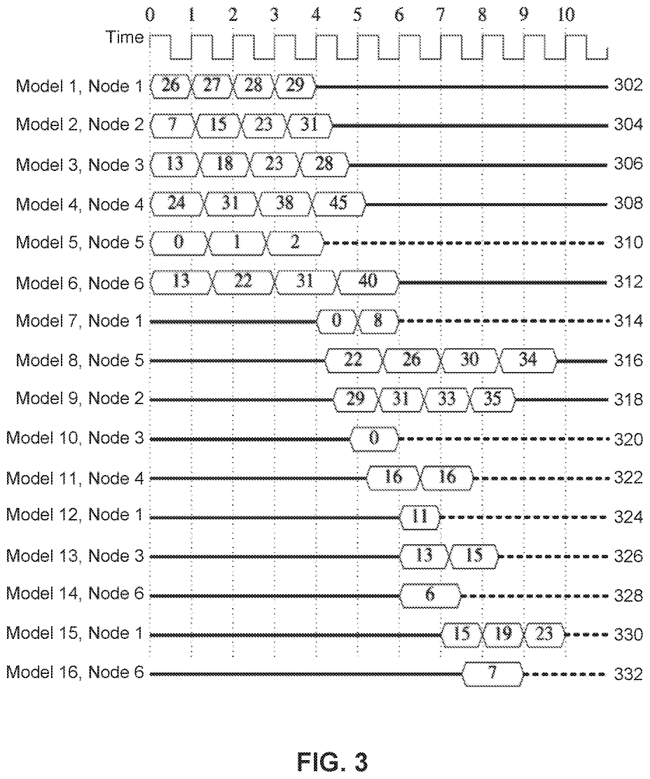

FIG. 3 is a conceptual illustration of a hyperparameter metaoptimization technique performed by training engine 122 and selection engine 124 of FIG. 1, according to various embodiments. As shown, the illustration of FIG. 3 includes sixteen timelines 302-332 depicting the training of 16 machine learning models on six processing nodes over time, based on an eviction rate (e.g., eviction rate 220) of 0.25 and four training phases (e.g., training phases 214-216). According to Equation 2 above, the minimum number of machine learning models allowed to continue at the end of the first, second, and third phases are W₁^{DCM}=8, W₂^{DCM}=6, and W₄^{DCM}=4 respectively.

In one embodiment, training engine 122 initializes all six processing nodes to train the first six machine learning models through the first three training phases, as shown in timelines 302-312. As shown in timeline 302, the first processing node is the first to complete all four training phases with the first machine learning model after 4 “units” of time. The first processing node also reports performance metrics of 26, 27, 28, and 29 after the end of the first, second, third, and fourth training phases, respectively. As shown in timeline 314, training engine 122 configures the first processing node to start training the seventh machine learning model as soon as training of the first machine learning model is complete.

As shown in timeline 310, after about 4.2 units of time, the fifth processing node has completed three training phases with the fifth machine learning model. At this point, selection engine 124 switches from DCM to SM for all machine learning models that subsequently complete the third training phase. Machine learning models that have previously completed the third training phase (i.e., the first four machine learning models) are unaffected by SM because they have already started the fourth training phase.

The fifth machine learning model reports a low performance metric of 2 at the end of the third training phase. As a result, training of the fifth machine learning model is terminated before the beginning of the fourth training phase, and training engine 122 reallocates the fifth processing node to begin training the eighth machine learning model, as shown in timeline 316.

As shown in timeline 312, after about 4.5 units of time, the sixth machine learning model reports a performance metric of 31 at the end of the third training phase. Because the performance metric is in the top half of performance metrics reported at the end of the third training phase, the sixth machine learning model is allowed to proceed to the last training phase.

After about 6 units of time, nine machine learning models have reported performance metrics after the first training phase, and six machine learning models have reported performance metrics after the second training phase. As shown in timeline 314, the seventh training model reports a performance metric of 8 after the second training phase. As a result, training of the seventh machine learning model is terminated before the beginning of the third training phase, and the first processing node is reallocated to train the twelfth machine learning model, as shown in line 324.

Similarly, as shown in timeline 320, training of the tenth machine learning model is terminated before the beginning of the second training phase because the tenth training model reports a low performance metric of 0 after the first training phase. Instead, training engine 122 reallocates the third processing node to begin training the thirteenth machine learning model, as shown in timeline 326.

The entire metaoptimization process illustrated in FIG. 3 requires about 10 units of time to complete. At the conclusion of the process, the first four, sixth, eighth, and ninth machine learning models have completed all four training phases; the fifth and fifteenth machine learning models have been terminated after three training phases; the seventh, eleventh, and thirteenth machine learning models have been terminated after two training phases; and the tenth, twelfth, fourteenth, and sixteenth machine learning models have been terminated after the first training phase.

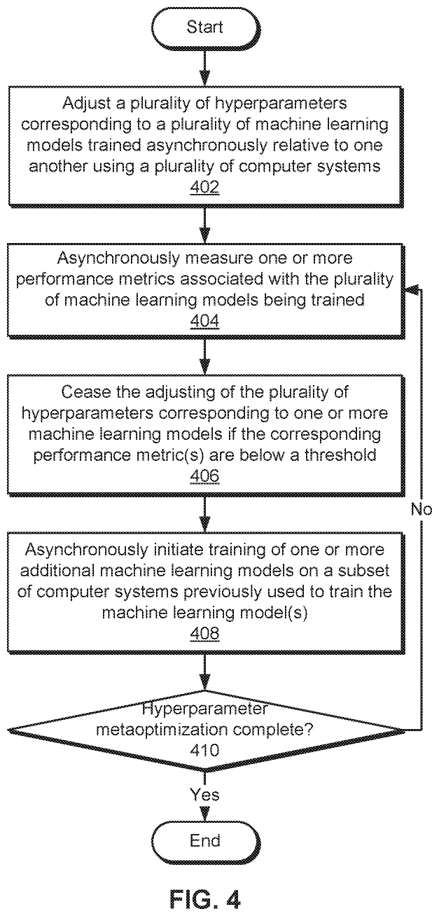

FIG. 4 is a flow diagram of method steps for performing hyperparameter metaoptimization, according to various embodiments. Although the method steps are described in conjunction with the systems of FIGS. 1 and 2, persons skilled in the art will understand that any system configured to perform the method steps in any order falls within the scope of the present disclosure.

As shown, training engine 122 adjusts 402 a plurality of hyperparameters corresponding to a plurality of machine learning models trained asynchronously relative to one another using a plurality of computer systems. For example, training engine 122 may use a grid search, random search, Bayesian optimization, and/or another hyperparameter search technique to select a set of hyperparameter values for each neural network in a plurality of neural networks. The hyperparameters may include, but are not limited to, a learning rate, a regularization parameter, a convergence parameter, a model topology, a number of training samples, a parameter-optimization technique, and/or a model type.

Next, training engine 122 and/or processing nodes 202-204 asynchronously measure 204 one or more performance metrics associated with the plurality of machine learning models being trained. For example, training engine 122 and/or processing nodes 202-204 may collect the performance metrics at the end of each training phase used to train the machine learning models. Because training of the model occurs asynchronously, the performance metrics may be collected from the machine learning models at different times (e.g., performance metrics may be collected from one machine learning model after the machine learning model completes a given training phase, which may occur before or after the same performance metrics are collected from another machine learning model completes the same training phase or a different training phase). The performance metrics may include, but are not limited to, a precision, recall, accuracy, ROC AUC, E/O ratio, and/or another measure of machine learning performance.

Training engine 122 and/or processing nodes 202-204 cease 406 the adjusting of the plurality of hyperparameters corresponding to one or more machine learning models if the corresponding performance metric(s) are below a threshold. For example, training engine 122 and/or processing nodes 202-204 may select the machine learning model(s) for early stopping before the machine learning model(s) complete all training phases based on performance metrics for the machine learning models, an eviction rate associated with training the machine learning models, and training speeds and/or phase completion times associated with training the machine learning models. A machine learning model with high performance metrics and/or that finishes a training phase more quickly or earlier than other machine learning models may be allowed to continue to a subsequent training phase, while a machine learning model with low performance metrics and/or that finishes a training phase more slowly or later than other machine learning models may be terminated before beginning the next training phase. Phase completion times of the machine learning models may additionally be adjusted based on the number of computational resources used to train the machine learning models.

Training engine 122 and/or processing nodes 202-204 then asynchronously initiate 408 training of one or more additional machine learning models on a subset of computer systems (e.g., one or more processing nodes 202-204) previously used to train the terminated machine learning model(s). For example, training engine 122 may reconfigure the subset of computer systems to begin the first training phase for the additional machine learning model(s). As a result, training engine 122 may ensure that all available computational resources on the computer systems are fully utilized during the metaoptimization process.

Training engine 122 optionally continues asynchronously measuring 404 performance metrics, terminating 406 hyperparameter exploration using one or more machine learning models, and asynchronously initiating 408 training of one or more additional machine learning models until the hyperparameter metaoptimization process is complete 410. For example, training engine 122 may asynchronously terminate a certain proportion of low-performing and/or late-finishing machine learning models at the end of each training phase and asynchronously replace the terminated machine learning models and/or machine learning models that have completed all training phases with new machine learning models and corresponding hyperparameters until all machine learning models to which hyperparameters have been assigned have completed training or have been terminated early.

### Example Hardware Architecture

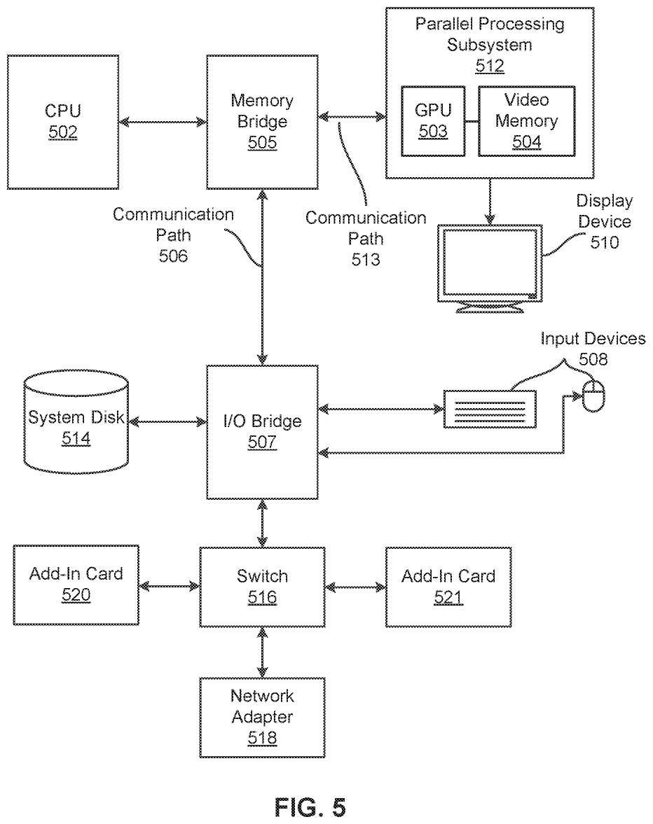

FIG. 5 is a block diagram illustrating a computer system 500 configured to implement one or more aspects of various embodiments. In some embodiments, computer system 500 is a server machine operating in a data center or a cloud computing environment that provides scalable computing resources as a service over a network. In some embodiments, computer system 500 implements the functionality of computing device 100 of FIG. 1.

In various embodiments, computer system 500 includes, without limitation, a central processing unit (CPU) 502 and a system memory 504 coupled to a parallel processing subsystem 512 via a memory bridge 505 and a communication path 513. Memory bridge 505 is further coupled to an I/O (input/output) bridge 507 via a communication path 506, and I/O bridge 507 is, in turn, coupled to a switch 516.

In one embodiment, I/O bridge 507 is configured to receive user input information from optional input devices 508, such as a keyboard or a mouse, and forward the input information to CPU 502 for processing via communication path 506 and memory bridge 505. In some embodiments, computer system 500 may be a server machine in a cloud computing environment. In such embodiments, computer system 500 may not have input devices 508. Instead, computer system 500 may receive equivalent input information by receiving commands in the form of messages transmitted over a network and received via the network adapter 518. In one embodiment, switch 516 is configured to provide connections between I/O bridge 507 and other components of the computer system 500, such as a network adapter 518 and various add-in cards 520 and 521.

In one embodiment, I/O bridge 507 is coupled to a system disk 514 that may be configured to store content and applications and data for use by CPU 502 and parallel processing subsystem 512. In one embodiment, system disk 514 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 507 as well.

In various embodiments, memory bridge 505 may be a Northbridge chip, and I/O bridge 507 may be a Southbridge chip. In addition, communication paths 506 and 513, as well as other communication paths within computer system 500, may be implemented using any technically suitable protocols, including, without limitation, AGP (Accelerated Graphics Port), HyperTransport, or any other bus or point-to-point communication protocol known in the art.

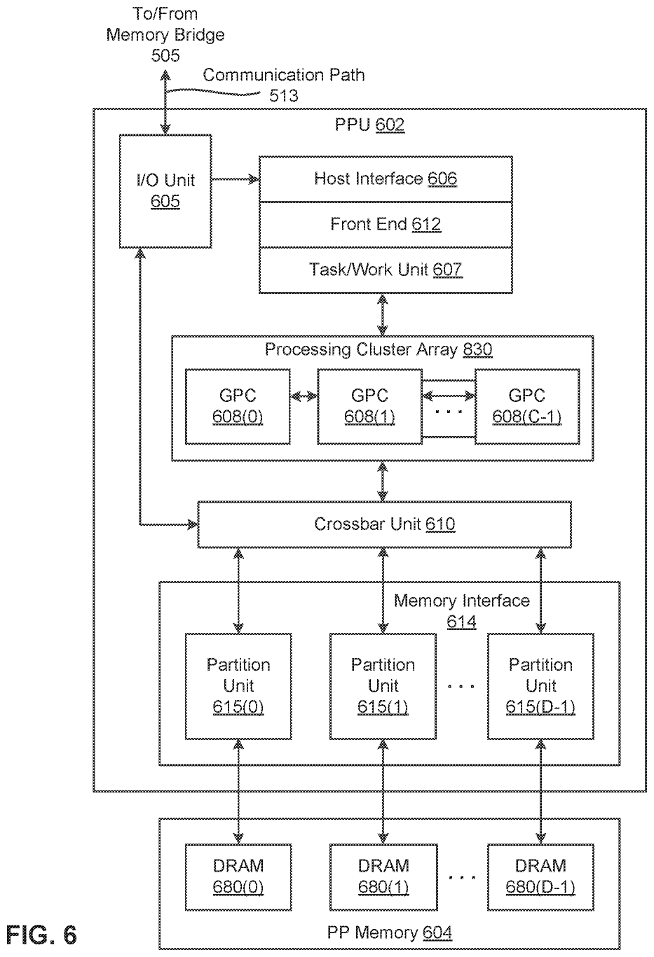

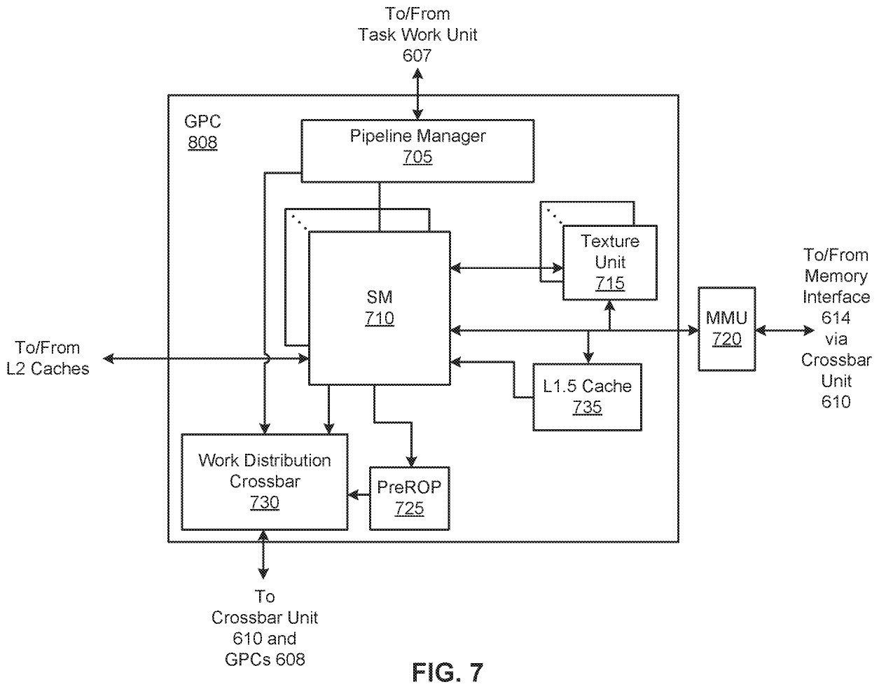

In some embodiments, parallel processing subsystem 512 comprises a graphics subsystem that delivers pixels to an optional display device 510 that may be any conventional cathode ray tube, liquid crystal display, light-emitting diode display, or the like. In such embodiments, the parallel processing subsystem 512 incorporates circuitry optimized for graphics and video processing, including, for example, video output circuitry. As described in greater detail below in conjunction with FIGS. 6 and 7, such circuitry may be incorporated across one or more parallel processing units (PPUs), also referred to herein as parallel processors, included within parallel processing subsystem 512.

In other embodiments, the parallel processing subsystem 512 incorporates circuitry optimized for general purpose and/or compute processing. Again, such circuitry may be incorporated across one or more PPUs included within parallel processing subsystem 512 that are configured to perform such general purpose and/or compute operations. In yet other embodiments, the one or more PPUs included within parallel processing subsystem 512 may be configured to perform graphics processing, general purpose processing, and compute processing operations. System memory 504 includes at least one device driver configured to manage the processing operations of the one or more PPUs within parallel processing subsystem 512.

In various embodiments, parallel processing subsystem 512 may be integrated with one or more of the other elements of FIG. 5 to form a single system. For example, parallel processing subsystem 512 may be integrated with CPU 502 and other connection circuitry on a single chip to form a system on chip (SoC).

In one embodiment, CPU 502 is the master processor of computer system 500, controlling and coordinating operations of other system components. In one embodiment, CPU 502 issues commands that control the operation of PPUs. In some embodiments, communication path 513 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 502, and the number of parallel processing subsystems 512, may be modified as desired. For example, in some embodiments, system memory 504 could be connected to CPU 502 directly rather than through memory bridge 505, and other devices would communicate with system memory 504 via memory bridge 505 and CPU 502. In other embodiments, parallel processing subsystem 512 may be connected to I/O bridge 507 or directly to CPU 502, rather than to memory bridge 505. In still other embodiments, I/O bridge 507 and memory bridge 505 may be integrated into a single chip instead of existing as one or more discrete devices. Lastly, in certain embodiments, one or more components shown in FIG. 5 may not be present. For example, switch 516 could be eliminated, and network adapter 518 and add-in cards 520, 521 would connect directly to I/O bridge 507.

FIG. 6 is a block diagram of a parallel processing unit (PPU) 602 included in the parallel processing subsystem 512 of FIG. 5, according to various embodiments. Although FIG. 6 depicts one PPU 602, as indicated above, parallel processing subsystem 512 may include any number of PPUs 602. As shown, PPU 602 is coupled to a local parallel processing (PP) memory 604. PPU 602 and PP memory 604 may be implemented using one or more integrated circuit devices, such as programmable processors, application specific integrated circuits (ASICs), or memory devices, or in any other technically feasible fashion.

In some embodiments, PPU 602 comprises a graphics processing unit (GPU) that may be configured to implement a graphics rendering pipeline to perform various operations related to generating pixel data based on graphics data supplied by CPU 502 and/or system memory 504. When processing graphics data, PP memory 604 can be used as graphics memory that stores one or more conventional frame buffers and, if needed, one or more other render targets as well. Among other things, PP memory 604 may be used to store and update pixel data and deliver final pixel data or display frames to an optional display device 510 for display. In some embodiments, PPU 602 also may be configured for general-purpose processing and compute operations. In some embodiments, computer system 500 may be a server machine in a cloud computing environment. In such embodiments, computer system 500 may not have a display device 510. Instead, computer system 500 may generate equivalent output information by transmitting commands in the form of messages over a network via the network adapter 518.

In some embodiments, CPU 502 is the master processor of computer system 500, controlling and coordinating operations of other system components. In one embodiment, CPU 502 issues commands that control the operation of PPU 602. In some embodiments, CPU 502 writes a stream of commands for PPU 602 to a data structure (not explicitly shown in either FIG. 5 or FIG. 6) that may be located in system memory 504, PP memory 604, or another storage location accessible to both CPU 502 and PPU 602. A pointer to the data structure is written to a command queue, also referred to herein as a pushbuffer, to initiate processing of the stream of commands in the data structure. In one embodiment, the PPU 602 reads command streams from the command queue and then executes commands asynchronously relative to the operation of CPU 502. In embodiments where multiple pushbuffers are generated, execution priorities may be specified for each pushbuffer by an application program via device driver to control scheduling of the different pushbuffers.

In one embodiment, PPU 602 includes an I/O (input/output) unit 605 that communicates with the rest of computer system 500 via the communication path 513 and memory bridge 505. In one embodiment, I/O unit 605 generates packets (or other signals) for transmission on communication path 513 and also receives all incoming packets (or other signals) from communication path 513, directing the incoming packets to appropriate components of PPU 602. For example, commands related to processing tasks may be directed to a host interface 606, while commands related to memory operations (e.g., reading from or writing to PP memory 604) may be directed to a crossbar unit 610. In one embodiment, host interface 606 reads each command queue and transmits the command stream stored in the command queue to a front end 612.

As mentioned above in conjunction with FIG. 5, the connection of PPU 602 to the rest of computer system 500 may be varied. In some embodiments, parallel processing subsystem 512, which includes at least one PPU 602, is implemented as an add-in card that can be inserted into an expansion slot of computer system 500. In other embodiments, PPU 602 can be integrated on a single chip with a bus bridge, such as memory bridge 505 or I/O bridge 507. Again, in still other embodiments, some or all of the elements of PPU 602 may be included along with CPU 502 in a single integrated circuit or system of chip (SoC).

In one embodiment, front end 612 transmits processing tasks received from host interface 606 to a work distribution unit (not shown) within task/work unit 607. In one embodiment, the work distribution unit receives pointers to processing tasks that are encoded as task metadata (TMD) and stored in memory. The pointers to TMDs are included in a command stream that is stored as a command queue and received by the front end unit 612 from the host interface 606. Processing tasks that may be encoded as TMDs include indices associated with the data to be processed as well as state parameters and commands that define how the data is to be processed. For example, the state parameters and commands could define the program to be executed on the data. Also for example, the TMD could specify the number and configuration of the set of CTAs. Generally, each TMD corresponds to one task. The task/work unit 607 receives tasks from the front end 612 and ensures that GPCs 608 are configured to a valid state before the processing task specified by each one of the TMDs is initiated. A priority may be specified for each TMD that is used to schedule the execution of the processing task. Processing tasks also may be received from the processing cluster array 630. Optionally, the TMD may include a parameter that controls whether the TMD is added to the head or the tail of a list of processing tasks (or to a list of pointers to the processing tasks), thereby providing another level of control over execution priority.

In one embodiment, PPU 602 implements a highly parallel processing architecture based on a processing cluster array 630 that includes a set of C general processing clusters (GPCs) 608, where C 1. Each GPC 608 is capable of executing a large number (e.g., hundreds or thousands) of threads concurrently, where each thread is an instance of a program. In various applications, different GPCs 608 may be allocated for processing different types of programs or for performing different types of computations. The allocation of GPCs 608 may vary depending on the workload arising for each type of program or computation.

In one embodiment, memory interface 614 includes a set of D of partition units 615, where D 1. Each partition unit 615 is coupled to one or more dynamic random access memories (DRAMs) 620 residing within PPM memory 604. In some embodiments, the number of partition units 615 equals the number of DRAMs 620, and each partition unit 615 is coupled to a different DRAM 620. In other embodiments, the number of partition units 615 may be different than the number of DRAMs 620. Persons of ordinary skill in the art will appreciate that a DRAM 620 may be replaced with any other technically suitable storage device. In operation, various render targets, such as texture maps and frame buffers, may be stored across DRAMs 620, allowing partition units 615 to write portions of each render target in parallel to efficiently use the available bandwidth of PP memory 604.

In one embodiment, a given GPC 608 may process data to be written to any of the DRAMs 620 within PP memory 604. In one embodiment, crossbar unit 610 is configured to route the output of each GPC 608 to the input of any partition unit 615 or to any other GPC 608 for further processing. GPCs 608 communicate with memory interface 614 via crossbar unit 610 to read from or write to various DRAMs 620. In some embodiments, crossbar unit 610 has a connection to I/O unit 605, in addition to a connection to PP memory 604 via memory interface 614, thereby enabling the processing cores within the different GPCs 608 to communicate with system memory 504 or other memory not local to PPU 602. In the embodiment of FIG. 6, crossbar unit 610 is directly connected with I/O unit 605. In various embodiments, crossbar unit 610 may use virtual channels to separate traffic streams between the GPCs 608 and partition units 615.

In one embodiment, GPCs 608 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 602 is configured to transfer data from system memory 504 and/or PP memory 604 to one or more on-chip memory units, process the data, and write result data back to system memory 504 and/or PP memory 604. The result data may then be accessed by other system components, including CPU 502, another PPU 602 within parallel processing subsystem 512, or another parallel processing subsystem 512 within computer system 500.

In one embodiment, any number of PPUs 602 may be included in a parallel processing subsystem 512. For example, multiple PPUs 602 may be provided on a single add-in card, or multiple add-in cards may be connected to communication path 513, or one or more of PPUs 602 may be integrated into a bridge chip. PPUs 602 in a multi-PPU system may be identical to or different from one another. For example, different PPUs 602 might have different numbers of processing cores and/or different amounts of PP memory 604. In implementations where multiple PPUs 602 are present, those PPUs may be operated in parallel to process data at a higher throughput than is possible with a single PPU 602. Systems incorporating one or more PPUs 602 may be implemented in a variety of configurations and form factors, including, without limitation, desktops, laptops, handheld personal computers or other handheld devices, servers, workstations, game consoles, embedded systems, and the like.

FIG. 7 is a block diagram of a general processing cluster (GPC) 608 included in the parallel processing unit (PPU) 602 of FIG. 6, according to various embodiments. As shown, the GPC 608 includes, without limitation, a pipeline manager 705, one or more texture units 715, a preROP unit 725, a work distribution crossbar 730, and an L1.5 cache 735.

In one embodiment, GPC 608 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 608. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 608 is controlled via a pipeline manager 705 that distributes processing tasks received from a work distribution unit (not shown) within task/work unit 607 to one or more streaming multiprocessors (SMs) 710. Pipeline manager 705 may also be configured to control a work distribution crossbar 730 by specifying destinations for processed data output by SMs 710.

In various embodiments, GPC 608 includes a set of M of SMs 710, where M 1. Also, each SM 710 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 710 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In various embodiments, each SM 710 includes multiple processing cores. In one embodiment, the SM 710 includes a large number (e.g., 128, etc.) of distinct processing cores. Each core may include a fully-pipelined, single-precision, double-precision, and/or mixed precision processing unit that includes a floating point arithmetic logic unit and an integer arithmetic logic unit. In one embodiment, the floating point arithmetic logic units implement the IEEE 754-2008 standard for floating point arithmetic. In one embodiment, the cores include 64 single-precision (32-bit) floating point cores, 64 integer cores, 32 double-precision (64-bit) floating point cores, and 8 tensor cores.

In one embodiment, tensor cores configured to perform matrix operations, and, in one embodiment, one or more tensor cores are included in the cores. In particular, the tensor cores are configured to perform deep learning matrix arithmetic, such as convolution operations for neural network training and inferencing. In one embodiment, each tensor core operates on a 4×4 matrix and performs a matrix multiply and accumulate operation D=A×B+C, where A, B, C, and D are 4×4 matrices.

In one embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use tensor cores from a CUDA-C++ program. At the CUDA level, the warp-level interface assumes 16×16 size matrices spanning all 32 threads of the warp.

Neural networks rely heavily on matrix math operations, and complex multi-layered networks require tremendous amounts of floating-point performance and bandwidth for both efficiency and speed. In various embodiments, with thousands of processing cores, optimized for matrix math operations, and delivering tens to hundreds of TFLOPS of performance, the SMs 710 provide a computing platform capable of delivering performance required for deep neural network-based artificial intelligence and machine learning applications.

In various embodiments, each SM 710 may also comprise multiple special function units (SFUs) that perform special functions (e.g., attribute evaluation, reciprocal square root, and the like). In one embodiment, the SFUs may include a tree traversal unit configured to traverse a hierarchical tree data structure. In one embodiment, the SFUs may include texture unit configured to perform texture map filtering operations. In one embodiment, the texture units are configured to load texture maps (e.g., a 2D array of texels) from memory and sample the texture maps to produce sampled texture values for use in shader programs executed by the SM. In various embodiments, each SM 710 also comprises multiple load/store units (LSUs) that implement load and store operations between the shared memory/L1 cache and register files internal to the SM 710.

In one embodiment, each SM 710 is configured to process one or more thread groups. As used herein, a “thread group” or “warp” refers to a group of threads concurrently executing the same program on different input data, with one thread of the group being assigned to a different execution unit within an SM 710. A thread group may include fewer threads than the number of execution units within the SM 710, in which case some of the execution may be idle during cycles when that thread group is being processed. A thread group may also include more threads than the number of execution units within the SM 710, in which case processing may occur over consecutive clock cycles. Since each SM 710 can support up to G thread groups concurrently, it follows that up to G*M thread groups can be executing in GPC 608 at any given time.

Additionally, in one embodiment, a plurality of related thread groups may be active (in different phases of execution) at the same time within an SM 710. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 710, and m is the number of thread groups simultaneously active within the SM 710. In some embodiments, a single SM 710 may simultaneously support multiple CTAs, where such CTAs are at the granularity at which work is distributed to the SMs 710.

In one embodiment, each SM 710 contains a level one (L1) cache or uses space in a corresponding L1 cache outside of the SM 710 to support, among other things, load and store operations performed by the execution units. Each SM 710 also has access to level two (L2) caches (not shown) that are shared among all GPCs 608 in PPU 602. The L2 caches may be used to transfer data between threads. Finally, SMs 710 also have access to off-chip “global” memory, which may include PP memory 604 and/or system memory 504. It is to be understood that any memory external to PPU 602 may be used as global memory. Additionally, as shown in FIG. 7, a level one-point-five (L1.5) cache 735 may be included within GPC 608 and configured to receive and hold data requested from memory via memory interface 614 by SM 710. Such data may include, without limitation, instructions, uniform data, and constant data. In embodiments having multiple SMs 710 within GPC 608, the SMs 710 may beneficially share common instructions and data cached in L1.5 cache 735.

In one embodiment, each GPC 608 may have an associated memory management unit (MMU) 720 that is configured to map virtual addresses into physical addresses. In various embodiments, MMU 720 may reside either within GPC 608 or within the memory interface 614. The MMU 720 includes a set of page table entries (PTEs) used to map a virtual address to a physical address of a tile or memory page and optionally a cache line index. The MMU 720 may include address translation lookaside buffers (TLB) or caches that may reside within SMs 710, within one or more L1 caches, or within GPC 608.

In one embodiment, in graphics and compute applications, GPC 608 may be configured such that each SM 710 is coupled to a texture unit 715 for performing texture mapping operations, such as determining texture sample positions, reading texture data, and filtering texture data.

In one embodiment, each SM 710 transmits a processed task to work distribution crossbar 730 in order to provide the processed task to another GPC 608 for further processing or to store the processed task in an L2 cache (not shown), parallel processing memory 604, or system memory 504 via crossbar unit 610. In addition, a pre-raster operations (preROP) unit 725 is configured to receive data from SM 710, direct data to one or more raster operations (ROP) units within partition units 615, perform optimizations for color blending, organize pixel color data, and perform address translations.

It will be appreciated that the architecture described herein is illustrative and that variations and modifications are possible. Among other things, any number of processing units, such as SMs 710, texture units 715, or preROP units 725, may be included within GPC 608. Further, as described above in conjunction with FIG. 6, PPU 602 may include any number of GPCs 608 that are configured to be functionally similar to one another so that execution behavior does not depend on which GPC 608 receives a particular processing task. Further, each GPC 608 operates independently of the other GPCs 608 in PPU 602 to execute tasks for one or more application programs.

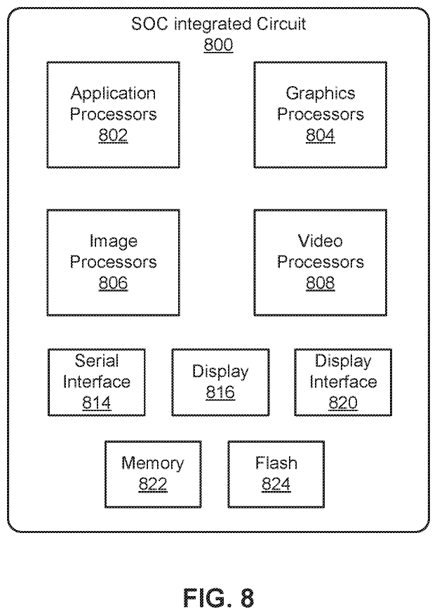

FIG. 8 is a block diagram of an exemplary system on a chip (SoC) integrated circuit 800, according to various embodiments. SoC integrated circuit 800 includes one or more application processors 802 (e.g., CPUs), one or more graphics processors 804 (e.g., GPUs), one or more image processors 806, and/or one or more video processors 808. SoC integrated circuit 800 also includes peripheral or bus components such as a serial interface controller 814 that implements Universal Serial Bus (USB), Universal Asynchronous Receiver/Transmitter (UART), Serial Peripheral Interface (SPI), Secure Digital Input Output (SDIO), inter-IC sound (I²S), and/or Inter-Integrated Circuit (I²C). SoC integrated circuit 800 additionally includes a display device 818 coupled to a display interface 820 such as high-definition multimedia interface (HDMI) and/or a mobile industry processor interface (MIPI). SoC integrated circuit 800 further includes a Flash memory subsystem 824 that provides storage on the integrated circuit, as well as a memory controller 822 that provides a memory interface for access to memory devices.

In one or more embodiments, SoC integrated circuit 800 is implemented using one or more types of integrated circuit components. For example, SoC integrated circuit 800 may include one or more processor cores for application processors 802 and/or graphics processors 804. Additional functionality associated with serial interface controller 814, display device 818, display interface 820, image processors 806, video processors 808, AI acceleration, machine vision, and/or other specialized tasks may be provided by application-specific integrated circuits (ASICs), application-specific standard parts (ASSPs), field-programmable gate arrays (FPGAs), and/or other types of customized components.

In sum, the disclosed techniques perform hyperparameter metaoptimization in an asynchronous distributed manner. During the hyperparameter metaoptimization, a set of processing nodes asynchronously train machine learning models using different hyperparameters over a series of training phases. After a certain proportion of machine learning models have completed a given training phase, the processing nodes begin terminating low-performing machine learning models and asynchronously begin training new machine learning models on computational resources previously used by the terminated machine learning models.

At least one technological advantage of the disclosed techniques is that available computational resources in the processing nodes are fully utilized without requiring preemption management on the processing nodes. Another technological advantage of the disclosed techniques includes a balance between depth-based search from the continued execution of machine learning models that complete training phases early or quickly and breath-based search from the termination of underperforming machine learning models that complete training phases slowly or late. Consequently, the disclosed techniques provide technological improvements in computer systems, applications, and/or techniques for performing machine learning and/or hyperparameter metaoptimization.

1. In some embodiments, a method comprises adjusting a plurality of hyperparameters corresponding to a plurality of neural networks trained asynchronously relative to each other using a plurality of computer systems; asynchronously measuring one or more performance metrics associated with the plurality of neural networks being trained; and ceasing the adjusting of the plurality of hyperparameters corresponding to one or more of the plurality of neural networks if the one or more performance metrics associated with the one or more of the plurality of neural networks are below a threshold.

2. The method of clause 1, further comprising, upon ceasing the adjusting of the plurality of hyperparameters corresponding to the one or more of the plurality of neural networks, asynchronously initiating training of one or more additional neural networks on a subset of the plurality of computer systems previously used to train the one or more of the plurality of neural networks.

3. The method of clauses 1-2, wherein adjusting the plurality of hyperparameters comprises selecting a set of hyperparameter values for each neural network in the plurality of neural networks.

4. The method of clauses 1-3, wherein asynchronously measuring the one or more performance metrics comprises collecting the one or more performance metrics at an end of a training phase used to train a first neural network after a second neural network has previously completed the training phase.

5. The method of clauses 1-4, wherein ceasing the adjusting of the plurality of hyperparameters comprises increasing a proportion of the plurality of neural networks for which the adjusting of the plurality of hyperparameters is ceased with successive training phases used to train the plurality of neural networks.

6. The method of clauses 1-5, wherein ceasing the adjusting of the plurality of hyperparameters comprises selecting the one or more of the plurality of neural networks based on the one or more performance metrics associated with training the plurality of neural networks.

7. The method of clauses 1-6, wherein selecting the one or more of the plurality of neural networks comprises selecting a first neural network that completes a training phase at a first time for continued training; and selecting a second neural network with a performance metric that is lower than the threshold and that completes the training phase at a second time that is later than the first time for inclusion in the one or more of the plurality of neural networks.

8. The method of clauses 1-7, wherein selecting the one or more of the plurality of neural networks further comprises adjusting at least one of the first time and the second time based on a number of computational resources used to train at least one of the first neural network and the second neural network.

9. The method of clauses 1-8, wherein the threshold comprises a quantile associated with the one or more performance metrics.

10. The method of clauses 1-9, wherein the plurality of hyperparameters comprise at least one of a learning rate, a regularization parameter, a convergence parameter, a model topology, a number of training samples, a parameter-optimization technique, and a model type.

11. In some embodiments, a non-transitory computer readable medium stores instructions that, when executed by a processor, cause the processor to at least adjust a plurality of hyperparameters corresponding to a plurality of machine learning models trained asynchronously relative to each other using a plurality of computer systems; asynchronously measure one or more performance metrics associated with the plurality of machine learning models being trained; and cease the adjusting of the plurality of hyperparameters corresponding to one or more of the plurality of machine learning models if the one or more performance metrics associated with the one or more of the plurality of machine learning models is below a threshold.

12. The non-transitory computer-readable medium of clause 11, further storing instructions that, when executed by the processor, cause the processor to at least asynchronously initiate training of one or more additional machine learning models on a subset of the plurality of computer systems previously used to train the one or more of the plurality of machine learning models.

13. The non-transitory computer-readable medium of clauses 11-12, wherein ceasing the adjusting of the plurality of hyperparameters comprises selecting the one or more of the plurality of machine learning models based on the one or more performance metrics and an eviction rate associated with training of the plurality of machine learning models.

14. The non-transitory computer-readable medium of clauses 11-13, wherein asynchronously measuring the one or more performance metrics associated with the plurality of machine learning models being trained comprises collecting the one or more performance metrics up to a maximum number of training phases used to asynchronously train the plurality of machine learning models.

15. The non-transitory computer-readable medium of clauses 11-14, wherein adjusting the plurality of hyperparameters comprises selecting a set of hyperparameter values for each machine learning model in the plurality of machine learning models.

16. In some embodiments, a system comprises a memory storing one or more instructions; and a processor that executes the instructions to at least adjust a plurality of hyperparameters corresponding to a plurality of machine learning models trained asynchronously relative to each other using a plurality of computer systems; asynchronously measure one or more performance metrics associated with the plurality of machine learning models being trained; and cease the adjusting of the plurality of hyperparameters corresponding to one or more of the plurality of machine learning models if the one or more performance metrics associated with the one or more of the plurality of machine learning models is below a threshold.

17. The system of clause 16, wherein the processor further executes the instructions to at least asynchronously initiate training of one or more additional machine learning models on a subset of the plurality of computer systems previously used to train the one or more of the plurality of machine learning models.

18. The system of clauses 16-17, wherein ceasing the adjusting of the plurality of hyperparameters comprises selecting the one or more of the plurality of machine learning models based on the one or more performance metrics, an eviction rate associated with training the plurality of machine learning models, and training speeds associated with training the plurality of machine learning models.

19. The system of clauses 16-18, wherein the plurality of hyperparameters comprise at least one of a learning rate, a regularization parameter, a convergence parameter, a model topology, a number of training samples, a parameter-optimization technique, and a model type.

20. The system of clauses 16-19, wherein the plurality of machine learning models comprise a neural network.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
adjusting a plurality of hyperparameters corresponding to a plurality of neural networks trained asynchronously relative to each other using a plurality of computer systems;
asynchronously measuring one or more performance metrics associated with the plurality of neural networks being trained; and
ceasing the adjusting of the plurality of hyperparameters corresponding to one or more of the plurality of neural networks if the one or more performance metrics associated with the one or more of the plurality of neural networks are below a threshold.

2. The method of claim 1, further comprising, upon ceasing the adjusting of the plurality of hyperparameters corresponding to the one or more of the plurality of neural networks, asynchronously initiating training of one or more additional neural networks on a subset of the plurality of computer systems previously used to train the one or more of the plurality of neural networks.

3. The method of claim 1, wherein adjusting the plurality of hyperparameters comprises selecting a set of hyperparameter values for each neural network in the plurality of neural networks.

4. The method of claim 1, wherein asynchronously measuring the one or more performance metrics comprises collecting the one or more performance metrics at an end of a training phase used to train a first neural network after a second neural network has previously completed the training phase.

5. The method of claim 1, wherein ceasing the adjusting of the plurality of hyperparameters comprises increasing a proportion of the plurality of neural networks for which the adjusting of the plurality of hyperparameters is ceased with successive training phases used to train the plurality of neural networks.

6. The method of claim 1, wherein ceasing the adjusting of the plurality of hyperparameters comprises selecting the one or more of the plurality of neural networks based on the one or more performance metrics associated with training the plurality of neural networks.

7. The method of claim 6, wherein selecting the one or more of the plurality of neural networks comprises:
selecting a first neural network that completes a training phase at a first time for continued training; and
selecting a second neural network with a performance metric that is lower than the threshold and that completes the training phase at a second time that is later than the first time for inclusion in the one or more of the plurality of neural networks.

8. The method of claim 6, wherein selecting the one or more of the plurality of neural networks further comprises adjusting at least one of the first time and the second time based on a number of computational resources used to train at least one of the first neural network and the second neural network.

9. The method of claim 1, wherein the threshold comprises a quantile associated with the one or more performance metrics.

10. The method of claim 1, wherein the plurality of hyperparameters comprise at least one of a learning rate, a regularization parameter, a convergence parameter, a model topology, a number of training samples, a parameter-optimization technique, and a model type.

11. A non-transitory computer readable medium storing instructions that, when executed by a processor, cause the processor to at least:
adjust a plurality of hyperparameters corresponding to a plurality of machine learning models trained asynchronously relative to each other using a plurality of computer systems;
asynchronously measure one or more performance metrics associated with the plurality of machine learning models being trained; and
cease the adjusting of the plurality of hyperparameters corresponding to one or more of the plurality of machine learning models if the one or more performance metrics associated with the one or more of the plurality of machine learning models is below a threshold.

12. The non-transitory computer-readable medium of claim 11, further storing instructions that, when executed by the processor, cause the processor to at least asynchronously initiate training of one or more additional machine learning models on a subset of the plurality of computer systems previously used to train the one or more of the plurality of machine learning models.

13. The non-transitory computer-readable medium of claim 11, wherein ceasing the adjusting of the plurality of hyperparameters comprises selecting the one or more of the plurality of machine learning models based on the one or more performance metrics and an eviction rate associated with training of the plurality of machine learning models.

14. The non-transitory computer-readable medium of claim 11, wherein asynchronously measuring the one or more performance metrics associated with the plurality of machine learning models being trained comprises collecting the one or more performance metrics up to a maximum number of training phases used to asynchronously train the plurality of machine learning models.

15. The non-transitory computer-readable medium of claim 11, wherein adjusting the plurality of hyperparameters comprises selecting a set of hyperparameter values for each machine learning model in the plurality of machine learning models.

16. A system, comprising:
a memory storing one or more instructions; and
a processor that executes the instructions to at least:
adjust a plurality of hyperparameters corresponding to a plurality of machine learning models trained asynchronously relative to each other using a plurality of computer systems;
asynchronously measure one or more performance metrics associated with the plurality of machine learning models being trained; and
cease the adjusting of the plurality of hyperparameters corresponding to one or more of the plurality of machine learning models if the one or more performance metrics associated with the one or more of the plurality of machine learning models is below a threshold.

17. The system of claim 16, wherein the processor further executes the instructions to at least asynchronously initiate training of one or more additional machine learning models on a subset of the plurality of computer systems previously used to train the one or more of the plurality of machine learning models.

18. The system of claim 16, wherein ceasing the adjusting of the plurality of hyperparameters comprises selecting the one or more of the plurality of machine learning models based on the one or more performance metrics, an eviction rate associated with training the plurality of machine learning models, and training speeds associated with training the plurality of machine learning models.

19. The system of claim 16, wherein the plurality of hyperparameters comprise at least one of a learning rate, a regularization parameter, a convergence parameter, a model topology, a number of training samples, a parameter-optimization technique, and a model type.

20. The system of claim 16, wherein the plurality of machine learning models comprise a neural network.
